(19) United States
(12) Patent Application Publication
(10) Pub. No.: US 2024/0343100 A1
(43) Pub. Date: Oct. 17, 2024

(54) Vehicle Bra Device

(71) Applicant: Patricia Ramos, Antioch, CA (US)

(72) Inventor: Patricia Ramos, Antioch, CA (US)

(21) Appl. No.: 18/638,251

(22) Filed: Apr. 17, 2024

Related U.S. Application Data
(60) Provisional application No. 63/496,496, filed on Apr. 17, 2023.

(51) Int. Cl. B60J 11/06

(52) U.S. Cl. CPC B60J 11/06

(57) ABSTRACT

A car bra device is disclosed for a Chevrolet Camaro. The car bra device comprises a body component that is configured into two pieces of thin, leather material. The body component is then installed near the hood and at the base of the vehicle front, near the front grille area. A vinyl area can also be utilized, which ensures a license plate is still visible while using the device.

### CROSS-REFERENCE TO RELATED APPLICATION

The present application claims priority to, and the benefit of, U.S. Provisional Application No. 63/496,496, which was filed on Apr. 17, 2023, and is incorporated herein by reference in its entirety.

### FIELD OF THE INVENTION

The present invention relates generally to the field of vehicle bra devices. More specifically, the present invention relates to a car bra device for a Chevrolet Camaro. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in car bra devices. Generally, people may enjoy decorating their vehicle to make it look sleek and professional. However, modifications to a vehicle can be permanent and cause damage to the exterior or its exterior paint finish. Further, without a grille cover, bugs and debris can get inside a radiator and grille, ultimately causing damage to the vehicle.

Additionally, when vehicles are driving on roads their hood and/or grille can be damaged due to various objects that can fall on it after they are thrown against the vehicle by the impact of the wheels against the road, such as rocks, pebbles, sand and other debris which may be on the road. This is especially true for expensive sports cars which have fine paint finishes and are designed low to the ground.

Accordingly, there is a demand for an improved car bra device that can protect both the hood and the grille of vehicles from dirt and debris thrown from the road by the impact of the vehicle wheels against the roads. More particularly, there is a demand for a car bra device that is easy to install and aesthetically pleasing to look at.

Therefore, there exists a long-felt need in the art for a car bra device that provides users with a car bra for a Chevrolet Camaro. There is also a long-felt need in the art for a car bra device that features two pieces of leather that fit over the front grille and hood area of the vehicle. Further, there is a long-felt need in the art for a car bra device that is available in different styles and designs to accommodate all of a user's needs and preferences. Moreover, there is a long-felt need in the art for a device that improves the look and aesthetic of the vehicle. Further, there is a long-felt need in the art for a car bra device that prevents dirt and debris from getting stuck in the grille. Finally, there is a long-felt need in the art for a car bra device that can utilize a vinyl area to ensure a license plate is visible with the device.

The subject matter disclosed and claimed herein, in one embodiment thereof, comprises a car bra device. The device is a car bra for a Chevrolet Camaro model year 2014-2022. The car bra device comprises a body component that is configured into two pieces of thin, leather material. The body component is then installed near the hood and at the base of the vehicle front, near the front grille area. A vinyl area can also be utilized, which ensures a license plate is still visible while using the device. The car bra device is available in numerous colors, styles, and designs.

In this manner, the car bra device of the present invention accomplishes all of the foregoing objectives and provides users with a car bra for a Chevrolet Camaro. The device is a two-piece construction that fits over the hood area and front grille area of the vehicle. The device can be manufactured of leather material.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a car bra device. The device is a car bra for a Chevrolet Camaro model year 2014-2022. The car bra device comprises a body component that is configured into two pieces of thin, leather material. The body component is then installed near the hood and at the base of the vehicle front, near the front grille area.

In one embodiment, the car bra device is designed to fit smoothly over the hood and front grille area of a vehicle. Specifically, the car bra device comprises a body component that is configured into two components or pieces. The first component is designed to fit over a vehicle's hood, such that it covers the entire hood from the bottom of the windshield to the distal end of the hood. The first component is sized and shaped to conform to the hood of a Chevrolet Camaro, model year 2014-2022. Further, the first component secures over the distal end of the hood and has a pocket at the distal end. The pocket slides over the end of the hood and is secured in place. The opposing end of the first component extends towards the windshield and is secured in place, covering the entire hood. In one embodiment, the first component only partially covers the hood, near the distal end.

In one embodiment, the second component of the car bra device is designed to fit smoothly over the front grille area of the vehicle, such that it covers the entire grille area. The second component is sized and shaped to conform to the grille area of a Chevrolet Camaro, model year 2014-2022. Further, the second component secures over the grille area and is secured in place. Additionally, the second component has appropriately designed openings, so that the vehicle lights, air intake, and grille will not be obstructed or any other suitable components at the front of the vehicle, as is known in the art, such as other lights, including fog lights and parking or high beam lights. Thus, the second component does not interfere with the air intake and other accessories on the grille of the vehicle.

In one embodiment, the first and the second components are secured to the vehicle by any suitable means as is known in the art. In one embodiment, the securing means comprises a plurality of elastomeric cinching straps secured around the perimeter of the first and the second components, such that once the first and the second components are in place, a user pulls the cinching loops, which cinches the first and second components around the vehicle's hood and front grille area. In another embodiment, the securing means comprises a plurality of snaps or elastic edging, which acts to secure the first and the second components around the vehicle's hood and front grille area for use.

In one embodiment, the body component and the first and the second components are manufactured of resilient and strong materials, such as a thin, leather material, nylon, etc., or any other suitable materials as is known in the art, as long as the material is sufficiently thick and strong to provide an effective barrier of protection for the hood and front grille area when rocks, sand, and other road debris are thrown against the hood and front grille area. In yet another embodiment, the body component and the first and the second components are manufactured of a clear plastic material, that way once applied to the vehicle hood and front grille area, the clear material will not act to hide the color and stylized design of the vehicle hood and front grille area.

In one embodiment, the second component which covers the front grille area also comprises an opening that ensures the license plate is still visible while using the device. Further, in another embodiment, the opening is covered with a vinyl material or other suitable clear material, which allows the license plate to be protected and still visible while using the device. Further, in yet another embodiment, the openings over the vehicle lights can also be covered in a vinyl material or other suitable clear material, which allows the lights to be protected and still visible while using the device.

In another embodiment, the car bra device is available in numerous colors, styles, and designs, as is known in the art, depending on the needs and/or wants of a user.

In yet another embodiment, the car bra device comprises a plurality of indicia.

In yet another embodiment, a method of preventing debris from damaging a vehicle's grille and hood is disclosed. The method includes the steps of providing a car bra device comprising a body component configured in two pieces of leather material. The method also comprises inserting one of the two pieces of the device over the hood of the vehicle and securing it. Further, the method comprises securing the second of the two pieces of the device over the vehicle's front grille area. Finally, the method comprises utilizing the vehicle with the device secured to prevent debris from damaging the vehicle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the car bra device of the present invention showing the device in use in accordance with the disclosed architecture;

FIG. 2 illustrates a bottom perspective view of one embodiment of the car bra device of the present invention showing the hood area of the body component in accordance with the disclosed architecture;

FIG. 3 illustrates a perspective view of one embodiment of the car bra device of the present invention showing the device applied to a vehicle grille in accordance with the disclosed architecture;

FIG. 4 illustrates a perspective view of one embodiment of the car bra device of the present invention showing the device applied to the vehicle hood in accordance with the disclosed architecture;

FIG. 5 illustrates a perspective view of one embodiment of the car bra device of the present invention showing the cinching mechanism which secures the device to the vehicle in accordance with the disclosed architecture; and

FIG. 6 illustrates a flowchart showing the method of preventing debris from damaging a vehicle's grille and hood in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a car bra device that provides users with a car bra for a Chevrolet Camaro. There is also a long-felt need in the art for a car bra device that features two pieces of leather that fit over the front grille and hood area of the vehicle. Further, there is a long-felt need in the art for a car bra device that is available in different styles and designs to accommodate all of a user's needs and preferences. Moreover, there is a long-felt need in the art for a device that improves the look and aesthetic of the vehicle. Further, there is a long-felt need in the art for a car bra device that prevents dirt and debris from getting stuck in the grille. Finally, there is a long-felt need in the art for a car bra device that can utilize a vinyl area to ensure a license plate is visible with the device.

The present invention, in one exemplary embodiment, is a novel car bra device. The device is a car bra for a Chevrolet Camaro model year 2014-2022. The car bra device comprises a body component that is configured into two pieces of thin, leather material. The body component is then installed near the hood and at the base of the vehicle front, near the front grille area. A vinyl area can also be utilized, which ensures a license plate is still visible while using the device. The present invention also includes a novel method of preventing debris from damaging a vehicle's grille and hood. The method includes the steps of providing a car bra device comprising a body component configured in two pieces of leather material. The method also comprises inserting one of the two pieces of the device over the hood of the vehicle and securing it. Further, the method comprises securing the second of the two pieces of the device over the vehicle's front grille area. Finally, the method comprises utilizing the vehicle with the device secured to prevent debris from damaging the vehicle.

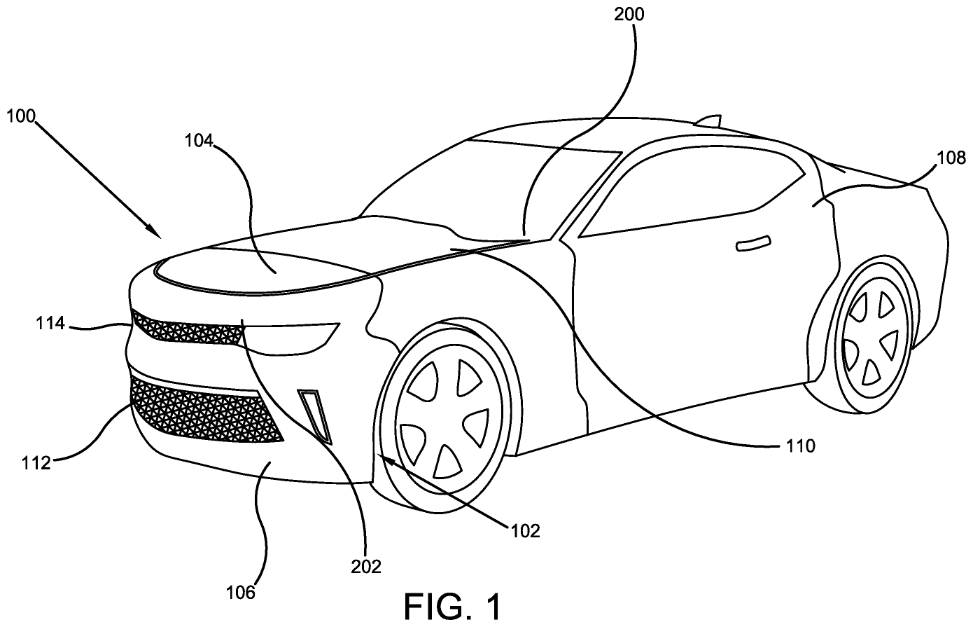

Referring initially to the drawings, FIG. 1 illustrates a perspective view of one embodiment of the car bra device 100 of the present invention. In the present embodiment, the car bra device 100 is an improved car bra device 100 that provides a user with a car bra for covering a front 114 of a vehicle 108 for preventing dirt and debris from damaging the vehicle 108. The car bra device 100 comprises a body component 102 configured into two pieces or components 104 and 106, for securing the device 100 to the vehicle 108. Specifically, the body component 102 is installed near the hood 110 and at the base of the vehicle front 114, near the front grille area 112.

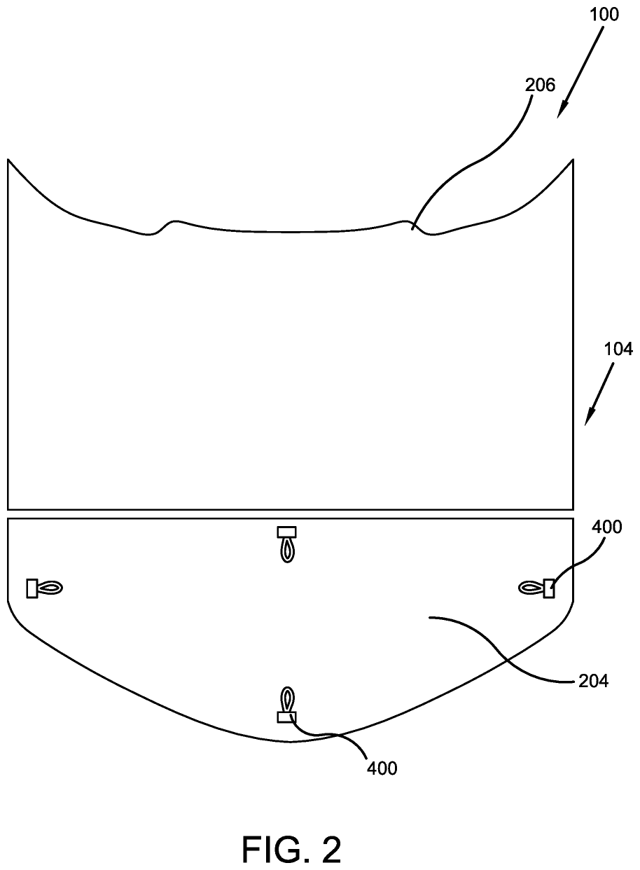

As shown in FIG. 2, the car bra device 100 is designed to fit smoothly over the hood 110 and front grille area 112 of a vehicle 108. Specifically, the car bra device 100 comprises a body component 102 that is configured into two components or pieces 104 and 106. The first component 104 is designed to fit over a vehicle's hood 110, such that it covers the entire hood 110 from the bottom of the windshield 200 to the distal end 202 of the hood 110. The first component 104 is sized and shaped to conform to the hood 110 of a Chevrolet Camaro, model year 2014-2022. Further, the first component 104 secures over the distal end 202 of the hood 110 and has a pocket 204 at the distal end 202. The pocket 204 slides over the end 202 of the hood 110 and is secured in place. The opposing end 206 of the first component 104 extends towards the windshield 200 and is secured in place, covering the entire hood 110. In one embodiment, the first component 104 only partially covers the hood 110, such as near the distal end 202, or any other suitable area of the hood 110 as is known in the art.

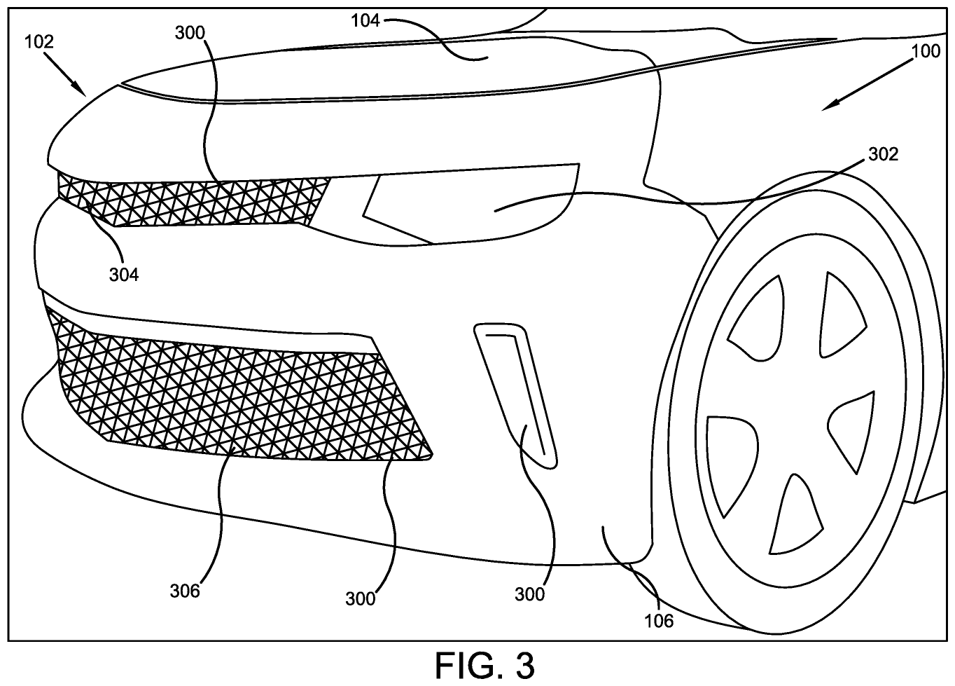

As shown in FIG. 3, the second component 106 of the car bra device 100 is designed to fit smoothly over the front grille area 112 of the vehicle 108, such that it covers the entire grille area 112. The second component 106 is sized and shaped to conform to the grille area 112 of a Chevrolet Camaro, model year 2014-2022. Further, the second component 106 secures over the grille area 112 and is secured in place. Additionally, the second component 106 has appropriately designed openings 300, so that the vehicle lights 302, air intake 304, and grille 306 will not be obstructed or any other suitable components at the front 114 of the vehicle 108, as is known in the art, such as other lights, including fog lights and parking or high beam lights. Thus, the second component 106 does not interfere with the air intake 304 and other accessories on the grille 306 of the vehicle 108.

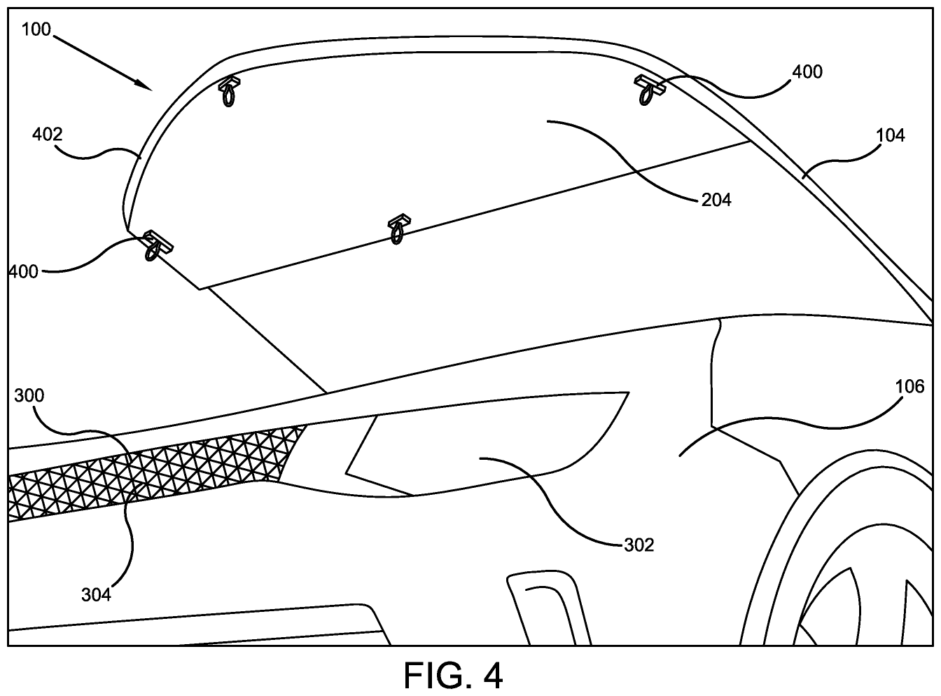

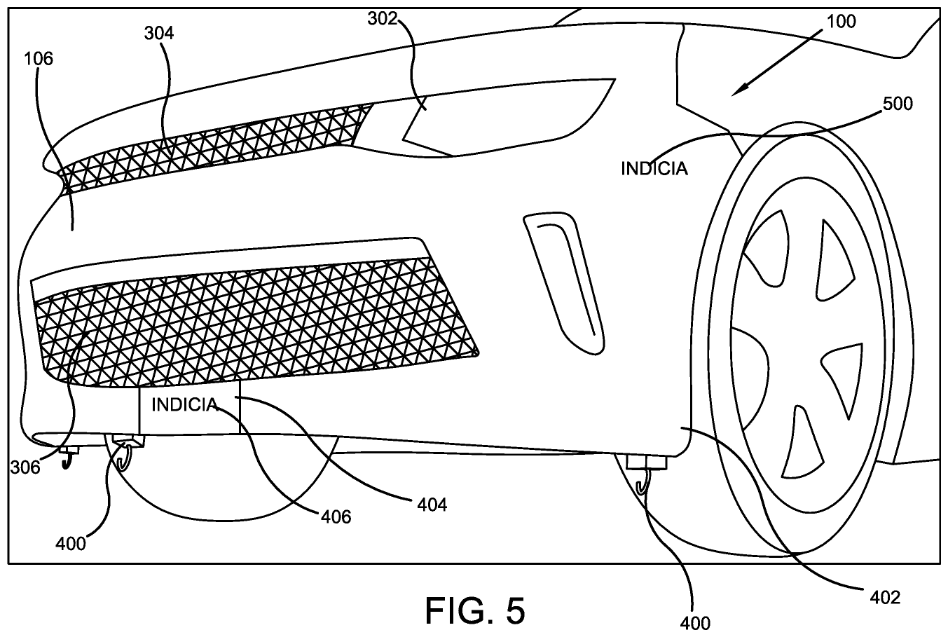

As shown in FIGS. 4-5, the first 104 and the second 106 components are secured to the vehicle 108 by any suitable means as is known in the art. In one embodiment, the securing means comprises a plurality of elastomeric cinching straps 400 secured around the perimeter 402 of the first 104 and the second 106 components, such that once the first 104 and the second 106 components are in place, a user pulls the cinching loops 400, which cinches the first 104 and second 106 components around the vehicle's hood 110 and front grille area 112. In another embodiment, the securing means comprises a plurality of snaps or clastic edging, which acts to secure the first 104 and the second 106 components around the vehicle's hood 110 and front grille area 112 for use.

In one embodiment, the body component 102 and the first 104 and the second 106 components are manufactured of resilient and strong materials, such as a thin, leather material, nylon, etc., or any other suitable materials as is known in the art, as long as the material is sufficiently thick and strong to provide an effective barrier of protection for the hood 110 and front grille area 112 when rocks, sand, and other road debris are thrown against the hood 110 and front grille area 112. In yet another embodiment, the body component 102 and the first 104 and the second 106 components are manufactured of a clear plastic material, that way once applied to the vehicle hood 110 and front grille area 112, the clear material will not act to hide the color and stylized design of the vehicle hood 110 and front grille area 112.

Furthermore, the second component 106 which covers the front grille area 112 also comprises an opening 404 which ensures the license plate 406 is still visible while using the device 100. Further, in another embodiment, the opening 404 is covered with a vinyl material or other suitable clear material, which allows the license plate 406 to be protected and still visible while using the device 100. Further, in yet another embodiment, the openings 300 over the vehicle lights 302 can also be covered in a vinyl material or other suitable clear material, which allows the lights 302 to be protected and still visible while using the device 100.

Additionally, the car bra device 100 is available in numerous colors, styles, and designs, as is known in the art, depending on the needs and/or wants of a user.

In yet another embodiment, the car bra device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be a vehicle, car bra, or brand related.

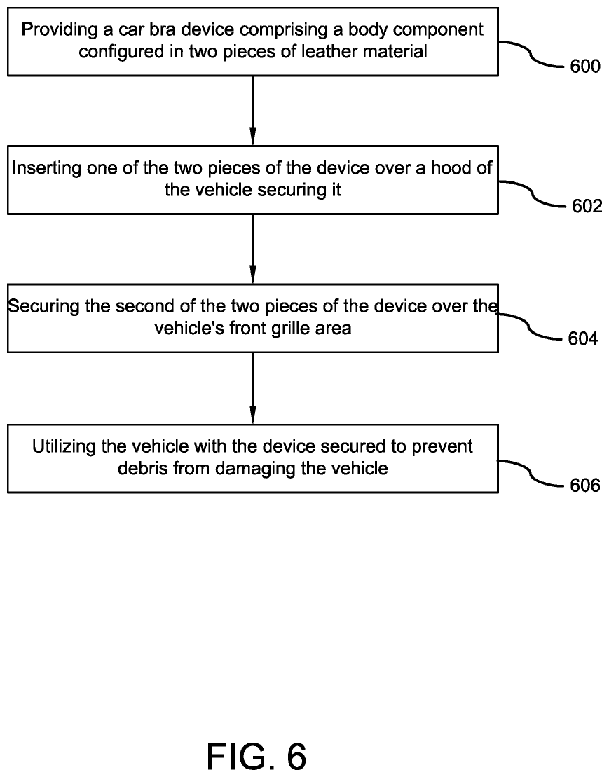

FIG. 6 illustrates a flowchart of the method of preventing debris from damaging a vehicle's grille and hood. The method includes the steps of at 600, providing a car bra device comprising a body component configured in two pieces of leather material. The method also comprises at 602, inserting one of the two pieces of the device over the hood of the vehicle and securing it. Further, the method comprises at 604, securing the second of the two pieces of the device over the vehicle's front grille area. Finally, the method comprises at 606, utilizing the vehicle with the device secured to prevent debris from damaging the vehicle.

Certain terms are used throughout the following description and claims to refer to particular features or components. As one skilled in the art will appreciate, different users, may refer to the same feature or component by different names. This document does not intend to distinguish between components or features that differ in name but not structure or function. As used herein “car bra device” and “device” are interchangeable and refer to the car bra device 100 of the present invention.

Notwithstanding the foregoing, the car bra device 100 of the present invention can be of any suitable size and configuration as is known in the art without affecting the overall concept of the invention, provided that it accomplishes the above stated objectives. One of ordinary skill in the art will appreciate the car bra device 100 as shown in FIGS. 1-6 is for illustrative purposes only, and many other sizes and shapes of the car bra device 100 are well within the scope of the present disclosure. Although the dimensions of the car bra device 100 are important design parameters for user convenience, the car bra device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A car bra device that provides a user with a protective covering for a front of a vehicle for preventing dirt and debris from damaging the vehicle, the car bra device comprising:
a body component;
wherein the body component is configured into two components; and
further wherein the body component is secured to a hood and a front grille area of a vehicle to protect the vehicle from dirt and debris.

2. The car bra device of claim 1, wherein the two components are sized and shaped to cover the hood and the front grille area of a Chevrolet Camaro, model year 2014-2022.

3. The car bra device of claim 2, wherein the two components comprise a first component and a second component.

4. The car bra device of claim 3, wherein the first component is configured to fit over a vehicle's hood, such that the first component covers the vehicle's hood from a bottom of a windshield to a distal end of the vehicle's hood.

5. The car bra device of claim 4, wherein the first component comprises a pocket at a distal end which slides over the distal end of the vehicle's hood.

6. The car bra device of claim 5, wherein the second component is configured to fit over a front grille area of the vehicle.

7. The car bra device of claim 6, wherein the second component comprises a plurality of openings, so that a vehicle lights, air intake, and grille will not be obstructed.

8. The car bra device of claim 7, wherein the second component comprises a license plate opening which ensures a license plate is still visible while using the car bra device.

9. The car bra device of claim 8, wherein the license plate opening is covered with a vinyl material to allow the license plate to be protected and still visible while using the car bra device.

10. The car bra device of claim 9, wherein the first and the second components are secured to a vehicle via a plurality of elastomeric cinching straps secured around a perimeter of the first and the second components.

11. The car bra device of claim 10, wherein once the first and the second components are in place on the vehicle's hood and the front grille area, a user pulls cinching loops from the plurality of elastomeric cinching straps to cinch the first and second components around the vehicle's hood and front grille area.

12. The car bra device of claim 1, wherein the body component is manufactured of a thin, leather material.

13. The car bra device of claim 1, wherein the body component is manufactured of a clear plastic material, such that the clear plastic material will not act to hide a color and stylized design of the vehicle's hood and front grille area.

14. A car bra device that provides a user with a protective covering for a front of a vehicle for preventing dirt and debris from damaging the vehicle, the car bra device comprising:
a body component; and
wherein the body component is configured into a first component and a second component;
wherein the first component and the second component are sized and shaped to cover a hood and a front grille area of a Chevrolet Camaro, model year 2014-2022;
wherein the first component is configured to fit over the hood and comprises a pocket at a distal end, which slides over a distal end of the hood;
wherein the second component is configured to fit over the front grille area;
wherein the second component comprises a plurality of openings, so that a vehicle lights, air intake, and grille will not be obstructed;
wherein the second component comprises a license plate opening which ensures a license plate is still visible; and
further wherein the first and the second components are secured via a plurality of elastomeric cinching straps secured around a perimeter of the first and the second components.

15. The car bra device of claim 14 further comprising a plurality of indicia.

16. The car bra device of claim 14, wherein once the first and the second components are in place on the hood and the front grille area, a user pulls cinching loops from the plurality of elastomeric cinching straps to cinch the first and second components around the hood and front grille area.

17. The car bra device of claim 14, wherein the body component is manufactured of a thin, leather material.

18. The car bra device of claim 14, wherein the body component is manufactured of a clear plastic material, such that the clear plastic material will not act to hide a color and stylized design of the vehicle's hood and front grille area.

19. The car bra device of claim 14, wherein the license plate opening is covered with a vinyl material to allow the license plate to be protected and still visible while using the car bra device.

20. A method of preventing debris from damaging a vehicle's grille and hood, the method comprising the following steps:
providing a car bra device comprising a body component configured in two pieces of leather material;
inserting one of the two pieces of the device over a hood of the vehicle and securing it;
securing the second of the two pieces of the device over the vehicle's front grille area; and
utilizing the vehicle with the device secured to prevent debris from damaging the vehicle.
